(19) United States
(12) Patent Application Publication
(10) Pub. No.: US 2026/0235498 A1
(43) Pub. Date: Aug. 13, 2026

(54) BIOSENSOR FOR GLUCOSE DETECTION

(71) Applicant: VisEra Technologies Company Ltd., Hsin-Chu City (TW)

(72) Inventors: Yi-Hsin TAI, Hsin-Chu City (TW); Hsin-Yi HSIEH, Hsin-Chu City (TW); Kuo-Fang CHUNG, Hsin-Chu City (TW); Po-Han FU, Hsin-Chu City (TW)

(21) Appl. No.: 19/050,358

(22) Filed: Feb. 11, 2025

(51) Int. Cl. G01N 21/25; G01N 21/27; G01N 21/31

(52) U.S. Cl. CPC G01N 21/255; G01N 21/27; G01N 21/3103; G01N 2201/068

(57) ABSTRACT

The present disclosure provides a biosensor for glucose detection including a meta-lens, a first grating coupler below the meta-lens, a first demultiplexer, and a plurality of first photodiodes below or levelled with the first demultiplexer. The meta-lens refracts an incident light into a first light beam and a second light beam spatially spaced apart from the first light beam, where a first wavelength range of the first light beam is non-overlapped with a second wavelength range of the second light beam. The first light beam is directed by the first grating coupler and demultiplexed into a plurality of first sub-light beams by the first demultiplexer. Each of the first sub-light beams has a peak wavelength, and each of the peak wavelengths is different from any of the other peak wavelengths. Each of the first sub-light beams is corresponding to each of the first photodiodes, respectively.

### BACKGROUND

### Field of Invention

The present disclosure relates to biosensor. More particularly, the present disclosure relates to the biosensor for glucose detection.

### Description of Related Art

Various spectroscopy including absorbance spectroscopy, Raman spectroscopy, and thermal emission spectroscopy can be used in a biosensor to detect glucose in a sample solution. Generally, the glucose in the sample provides a spectrum with specific peak features after absorbing or being excited by an incident light. As a result, the peak composition of the light obtained from the sample may affect the accuracy of the glucose detection. If the light from the sample has complex peak features, it becomes difficult to define or monitor the glucose concentration by the biosensor.

### SUMMARY

According to some embodiments of the present disclosure, the biosensor for glucose detection includes a meta-lens refracting an incident light into a first light beam and a second light beam spatially spaced apart from the first light beam, where a first wavelength range of the first light beam is non-overlapped with a second wavelength range of the second light beam. The biosensor also includes a first grating coupler below the meta-lens and directing the first light beam, a first demultiplexer, and a plurality of first photodiodes below or levelled with the first demultiplexer. The first demultiplexer demultiplexes the first light beam into a plurality of first sub-light beams. Each of the first sub-light beams has a peak wavelength, and each of the peak wavelengths is different from any of the other peak wavelengths. Each of the first sub-light beams is corresponding to each of the first photodiodes, respectively.

In some embodiments, the meta-lens includes a substrate and a plurality of nano-columns embedded in the substrate, and a refractive index of the nano-columns is larger than a refractive index of the substrate.

In some embodiments, the biosensor further includes a medium layer between the meta-lens and the first grating coupler, where a refractive index of the medium layer is smaller than the refractive index of the substrate.

In some embodiments, the meta-lens includes a plurality of meta-lens units. Each of the meta-lens units includes a first nano-column having a first diameter, a second nano-column having a second diameter larger than the first diameter, a third nano-column having a third diameter smaller than the first diameter and the second diameter, a fourth nano-column having a fourth diameter larger than the third diameter but smaller than the second diameter, a fifth nano-column having a fifth diameter larger than the fourth diameter but smaller than the second diameter, and a sixth nano-column having a sixth diameter larger than the fifth diameter but smaller than the second diameter. The first nano-column, the second nano-column, the third nano-column, the fourth nano-column, the fifth nano-column, and the sixth nano-column are sequentially arranged in a line.

In some embodiments, the first light beam is focused on the first grating coupler by the meta-lens.

In some embodiments, a minimum wavelength of the first wavelength range is larger than a maximum wavelength of the second wavelength range, and a first angle of refraction of the first light beam through the meta-lens is larger than a second angle of refraction of the second light beam through the meta-lens.

In some embodiments, a difference between the first angle of refraction and the second angle of refraction is equal to or larger than 15°.

In some embodiments, the first wavelength range is larger than the second wavelength range, and the first demultiplexer is an array waveguide grating.

In some embodiments, the first photodiodes are quantum dot organic photodiodes or Ge photodiodes.

In some embodiments, the first wavelength range is smaller than the second wavelength range, and the first demultiplexer is a micro ring resonator.

In some embodiments, the first photodiodes are organic photodiodes or inorganic photodiodes.

In some embodiments, the biosensor further includes a second grating coupler below the meta-lens and directing the second light beam, a second demultiplexer, and a plurality of second photodiodes below or levelled with the second demultiplexer. The second demultiplexer demultiplexes the second light beam into a plurality of second sub-light beams. Each of the second sub-light beams has a peak wavelength, and each of the peak wavelengths of the second sub-light beams is different from any of the other peak wavelengths. Each of the second sub-light beams is corresponding to each of the second photodiodes, respectively.

In some embodiments, the first demultiplexer is an array waveguide grating, the second demultiplexer is a micro ring resonator, and each of the first sub-light beams has a bandwidth larger than a bandwidth of each of the second sub-light beams.

In some embodiments, the second light beam reaching a top surface of the second grating coupler is spatially spaced apart from the first light beam reaching a top surface of the first grating coupler by a first distance D1, the first grating coupler and the second grating coupler are separated from the meta-lens by a second distance D2, the first light beam through the meta-lens has a first angle of refraction θ1 , and the second light beam through the meta-lens has a second angle of refraction θ2. A relationship between the first distance D1, the second distance D2, the first angle of refraction θ1, and the second angle of refraction θ2 meets: D1=(tan θ1−tan θ2)×D2.

In some embodiments, the first light beam and the second light beam are alternately irradiated onto the first grating coupler and the second grating coupler.

In some embodiments, the first grating coupler, the first demultiplexer, and the first photodiodes are connected by waveguides when the first photodiodes are levelled with the first demultiplexer.

In some embodiments, the biosensor further includes a plurality of second grating couplers when the first photodiodes are below the first demultiplexer, and the second grating couplers directs the first sub-light beams from the first demultiplexer to the first photodiodes.

In some embodiments, the first grating coupler, the first demultiplexer, and the second grating couplers are connected by waveguides.

In some embodiments, the biosensor further includes a reflective pattern above the second grating couplers.

In some embodiments, the biosensor further includes a reflective pattern below the first grating coupler.

According to the above-mentioned embodiments, the biosensor includes the meta-lens spatially distributing the light beams having different wavelength ranges, where one of the light beams is further demultiplexed into multiple sub-light beams by the demultiplexer and directed to multiple photodiodes. Since the light beams are spatially spaced apart before reaching the demultiplexer, the sub-light beams may be directed to the photodiodes with suitable bandwidth and within the specific wavelength range, thereby improving the accuracy and the signal-noise ratio of the biosensor.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A and FIG. 1B illustrate a three-dimensional schematic view and a schematic cross-sectional view of a biosensor for glucose detection, according to one embodiment of the present disclosure.

FIG. 1C illustrates a schematic view of the light paths in the biosensor in FIG. 1A and FIG. 1B.

FIG. 2A and FIG. 2B illustrate a schematic cross-sectional view and an enlarged top view of the meta-lens, according to some embodiments of the present disclosure.

FIG. 2C illustrates the light paths refracted by the meta-lens, according to some embodiment of the present disclosure.

FIG. 3A and FIG. 3B illustrate a three-dimensional schematic view and a schematic cross-sectional view of a biosensor for glucose detection, according to another embodiment of the present disclosure.

FIG. 4A and FIG. 4B illustrate a three-dimensional schematic view and a schematic cross-sectional view of a biosensor for glucose detection, according to another embodiment of the present disclosure.

FIG. 5A and FIG. 5B illustrate a three-dimensional schematic view and a schematic cross-sectional view of a biosensor for glucose detection, according to another embodiment of the present disclosure.

FIG. 6A and FIG. 6B illustrate a three-dimensional schematic view and a schematic cross-sectional view of a biosensor for glucose detection, according to another embodiment of the present disclosure.

FIG. 7A and FIG. 7B illustrate a three-dimensional schematic view and a schematic cross-sectional view of a biosensor for glucose detection, according to another embodiment of the present disclosure.

### DETAILED DESCRIPTION

The following disclosure provides many different embodiments, or examples, for implementing different features of the provided subject matter. Specific examples of components, arrangements, etc., are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

One of the sensing mechanisms that may be used for glucose is the absorbance spectroscopy. When an incident light with wavelengths between 700 nm and 1800 nm reaches the glucose sample, some wavelengths may be absorbed by the glucose while the other wavelengths pass through. As a result, an absorption signal between 1450 nm a 1550 nm may be detected to define the glucose concentration. Another sensing mechanism that may be used to detect the glucose concentration is the Raman spectroscopy. When an excitation light reaches the glucose sample, the Raman shift corresponding to the excitation wavelength may be obtained from the glucose. For example, a Raman signal between 850 nm and 860 nm may be detected after the glucose sample being excited by the excitation wavelength of 785 nm, and a Raman signal between 560 nm and 570 nm may be detected when the excitation wavelength is 532 nm.

When the glucose sample absorbs the incident light with broadband wavelengths, the absorption signal and the Raman signal may both be provided from the glucose sample. In this case, a mixed light of the absorption signal and the Raman signal will be detected by the biosensor. Since the absorption signal of glucose has longer wavelength and larger wavelength range than the Raman signal of glucose, it becomes difficult to accurately detect the two signals with a same detector in the biosensor.

The embodiments of the present disclosure provide a biosensor for glucose detection to separate the absorption signal and the Raman signal of glucose. The biosensor includes a meta-lens refracting the light beams with different wavelength ranges, a grating coupler directing one of the light beams into a demultiplexer that demultiplexes the light beam into a plurality of sub-light beams, and a plurality of photodiodes, where each of the sub-light beams is corresponding to each of the photodiodes, respectively. The light beams are spatially spaced apart before reaching the demultiplexer, so that one of the light beams can be directed to the demultiplexer with suitable free spectral range (FSR). Therefore, the photodiodes may detect the sub-light beams with suitable bandwidth and within the specific wavelength range, which improves the accuracy and the signal-noise ratio of the biosensor.

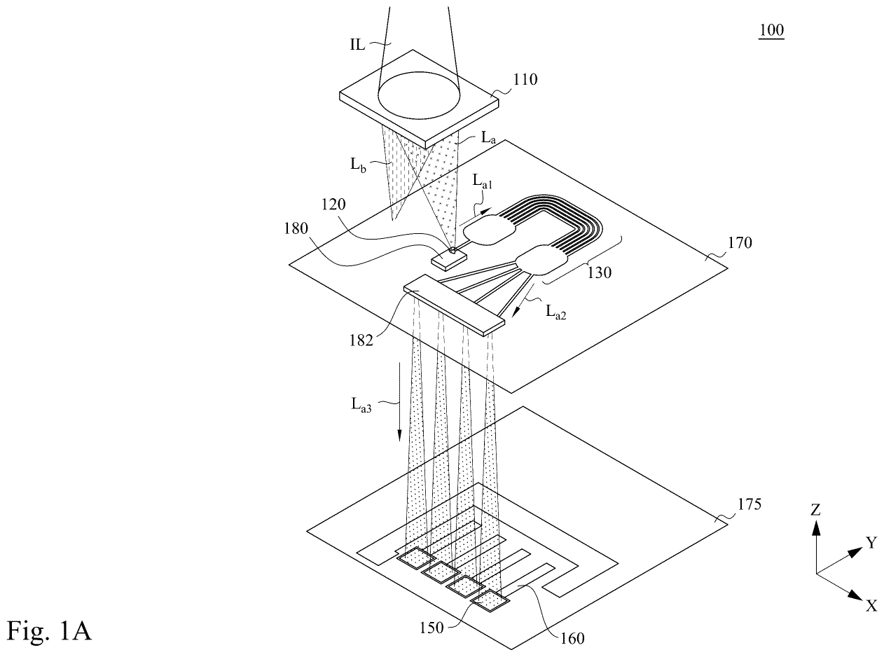

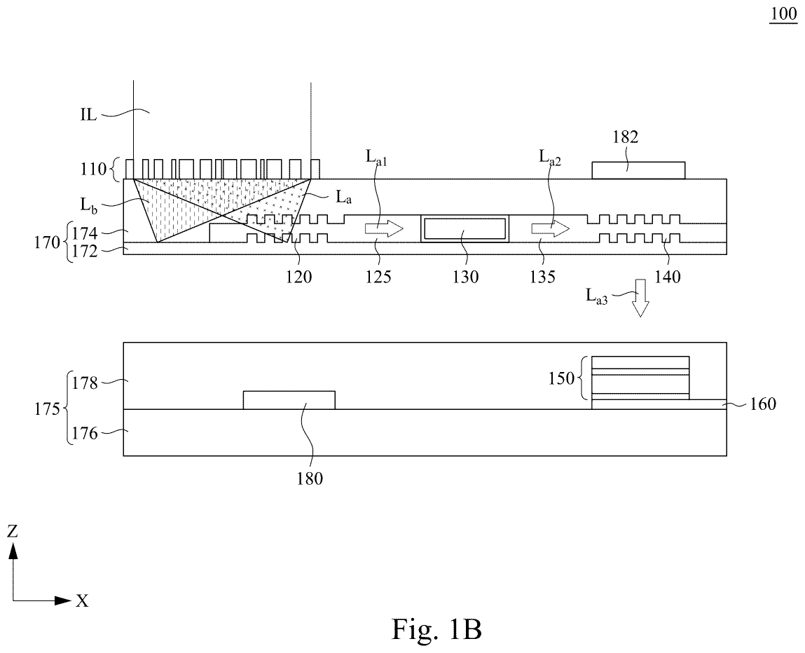

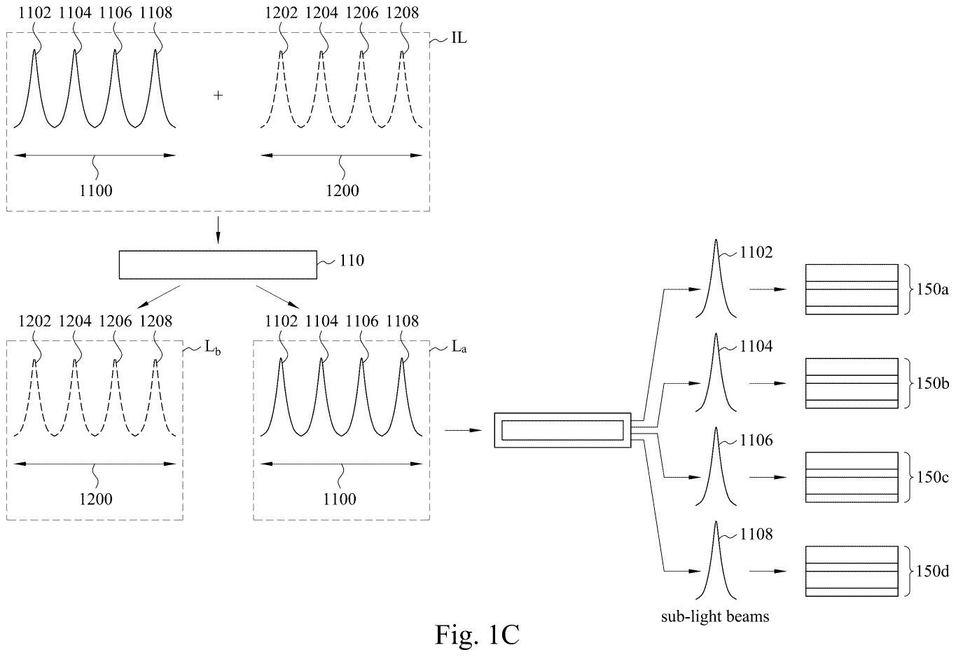

According to one embodiment of the present disclosure, FIG. 1A illustrates a three-dimensional schematic view of a biosensor 100 for glucose detection, and FIG. 1B illustrates a schematic cross-sectional view of the biosensor 100 in FIG. 1A. It should be noted that the schematic cross-sectional views of the biosensor of the present disclosure are illustrated basically parallel to Z-axis direction in the three-dimensional schematic views, and some elements of the biosensor are simplified or dimension-adjusted to clearly illustrate the light path in the biosensor.

Referring to FIG. 1A and FIG. 1B, the biosensor 100 includes a meta-lens 110 at the topmost layer closest to the incident light IL from a glucose sample (not shown). The incident light IL is a mixed light of at least two wavelength ranges, where the two wavelength ranges are non-overlapped with each other. For example, the incident light IL may have a first wavelength range of 1450 nm to 1550 nm corresponding to the absorption signal of glucose and a second wavelength range of 850 nm to 860 nm corresponding to the Raman signal of glucose. The meta-lens 110 refracts the incident light IL into a light beam Lₐ within the first wavelength range and a light beam L_{b} within the second wavelength range, where the light beam Lₐ and the light beam L_{b} are spatially spaced apart from each other before being collected by other elements below the meta-lens 110.

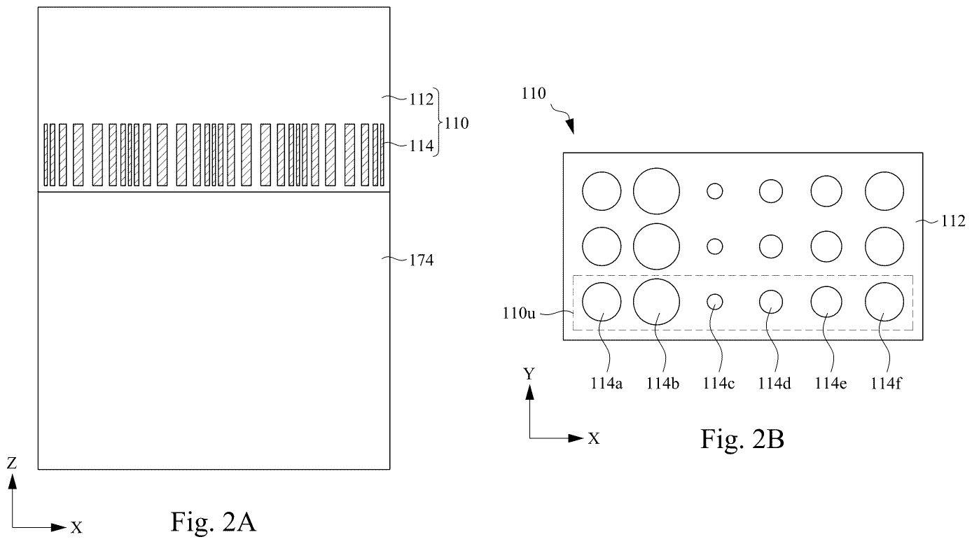

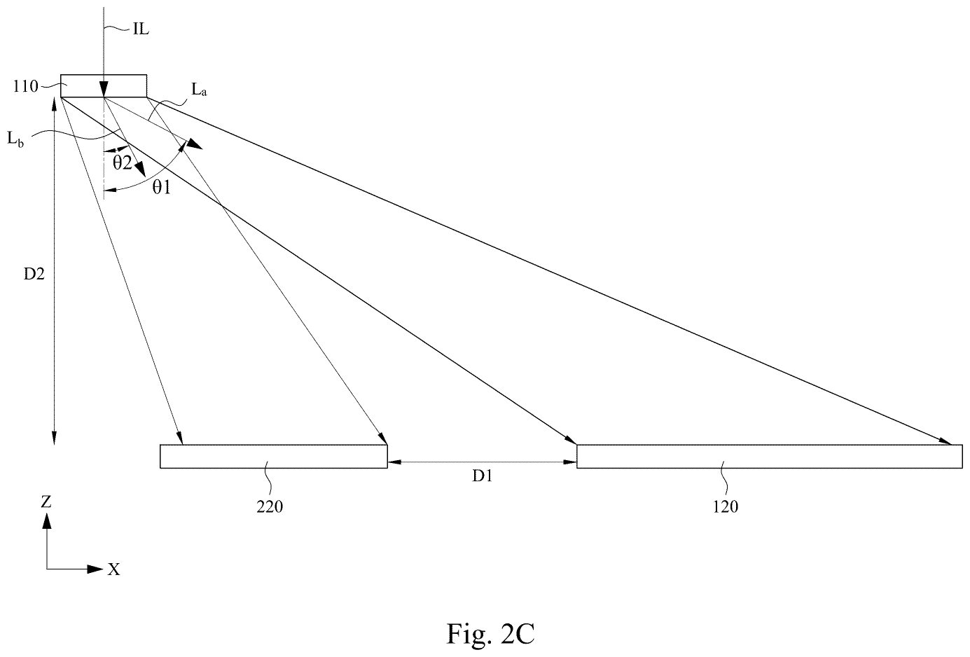

To further illustrate the details of the meta-lens 110, FIG. 2A illustrates a schematic cross-sectional view of the meta-lens 110. The meta-lens 110 includes a substrate 112 and a plurality of nano-columns 114 embedded in the substrate 112. The material of the substrate 112 may be different from the material of the nano-columns 114, such that the refractive index of the nano-columns 114 is larger than the refractive index of the substrate 112. For example, the substrate 112 may be made of glass with a refractive index about 1.5, while the nano-columns 114 are made of another material with a refractive index between 1.56 and 2.3, such as Si, Si₃N₄, Ta₂O₅, TiO₂, Nb₂O₅, or the like. The refractive index difference between the substrate 112 and the nano-columns 114 allows the meta-lens 110 to refract the incident light IL into the light beam Lₐ and the light beam L_{b} with significantly different angle of refraction.

In addition, the meta-lens 110 includes a plurality of meta-lens units 110u with the same arrangement of the nano-columns 114. The meta-lens units 110u are joined side by side in the meta-lens 110 to arrange the nano-columns 114 in a repeated pattern. According to some embodiments of the present disclosure, FIG. 2B illustrates an enlarged top view of the meta-lens 110 in FIG. 2A, where three meta-lens units 110u are illustrated in FIG. 2B. The meta-lens unit 110u includes six nano-columns 114 sequentially arranged in a line along X-axis direction. The first nano-column 114a at one end of the line has a first diameter, the second nano-column 114b next to the first nano-column 114a has a second diameter larger than the first diameter, the third nano-column 114c next to the second nano-column 114b has a third diameter smaller than the first diameter and the second diameter, the fourth nano-column 114d next to the third nano-column 114c has a fourth diameter larger than the third diameter but smaller than the second diameter, the fifth nano-column 114e next to the fourth nano-column 114d has a fifth diameter larger than the fourth diameter but smaller than the second diameter, and the sixth nano-column 114f next to the fifth nano-column 114e has a sixth diameter larger than the fifth diameter but smaller than the second diameter. The diameter variation between the nano-columns 114 improves the spatial distribution of the light beam Lₐ and the light beam L_{b}.

FIG. 2C illustrates the light paths refracted by the meta-lens 110, according to some embodiment of the present disclosure. As mentioned above, the incident light IL is refracted into the light beam Lₐ and the light beam L_{b} by the meta-lens 110, where the first wavelength range of the light beam Lₐ is non-overlapped with the second wavelength range of the light beam L_{b}. In the embodiments which the minimum wavelength of the first wavelength range is larger than the maximum wavelength of the second wavelength range, the angle of refraction θ1 of the light beam Lₐ may be larger than the angle of refraction θ2 of the light beam L_{b}. The difference between the angle of refraction θ1 and the angle of refraction θ2 may be equal to or larger than 15°, so that the light beam Lₐ and the light beam L_{b} may be easily split by the meta-lens 110. For example, the angle of refraction θ1 may be in a range of 38° to 40°, while the angle of refraction θ2 may be in a range of 20° to 21°.

The light beam Lₐ and the light beam L_{b} refracted by the meta-lens 110 travel in different directions and will be spatially spaced apart from each other after travelling a certain distance. The lateral distance between the light beam Lₐ and the light beam L_{b} is related to the angle of refraction and the travelling distance of the light beams. For example, the optical elements which the light beam Lₐ and the light beam L_{b} are respectively irradiated onto, such as grating coupler 120 and grating coupler 220 which will be discussed later, are below the meta-lens 110 by a distance D2 in Z-axis direction. The two optical elements are laterally separated from each other by a distance D1 in X-axis direction, where the distance D1 may be referred to as the spatially spaced apart distance between the light beam Lₐ reaching the top surface of the grating coupler 120 and the light beam L_{b} reaching the top surface of the grating coupler 220. As shown in FIG. 2C, the relationship between the distance D1, the distance D2, the angle of refraction θ1, and the angle of refraction θ2 meets: D1=(tan θ1−tan θ2)×D2. Therefore, the light beam Lₐ and the light beam L_{b} can be effectively split in a short light travelling distance (i.e., distance D2) when there is a large difference between the angle of refraction θ1 and the angle of refraction θ2, which is helpful to reduce the thickness of the biosensor.

Referring back to FIG. 1A and FIG. 1B, the biosensor 100 includes a grating coupler 120 below the meta-lens 110, a demultiplexer 130 connected to the grating coupler 120 by a waveguide 125, a plurality of grating couplers 140 connected to the demultiplexer 130 by waveguides 135, and a plurality of photodiodes 150 below the demultiplexer 130 and the grating couplers 140. The grating coupler 120 concentrates the light energy and adjusts the light travelling direction of the light beam Lₐ into the arrow Lₐ₁, so that the light beam Lₐ is directed to the demultiplexer 130 by the grating coupler 120 and the waveguide 125. In this case, the grating coupler 120 may be called as the input grating coupler. In some embodiments, the light beam Lₐ may be focused on the grating coupler 120 by the meta-lens 110 to improve the light collecting efficiency of the grating coupler 120.

The light beam Lₐ is then demultiplexed into a plurality of sub-light beams by the demultiplexer 130. Each of the sub-light beams has a peak wavelength, where each of the peak wavelengths is different from any of the other peak wavelengths. The number of the sub-light beams corresponds to the number of the channels in the demultiplexer 130, and the peak wavelength differences between the sub-light beams may relate to the FSR of the demultiplexer 130. For example, when the light beam Lₐ is the absorption signal of glucose, the demultiplexer 130 may be an array waveguide grating (AWG). The FSR of the array waveguide grating can be adjusted to about 100 nm, which is suitable to demultiplex the absorption signal having larger wavelength range, such as 1450 nm to 1550 nm. After the light beam Lₐ being demultiplexed by the array waveguide grating mentioned-above, the fall width at half maximum (FWHM) of each sub-light beam can be tuned about 10 nm. In addition, the sub-light beams produced by the array waveguide grating may have slightly cross talk, which improves the accuracy of the biosensor 100.

Each of the sub-light beams from the light beam Lₐ is then directed to a corresponding one of the grating couplers 140 by the waveguides 135. The arrow Lₐ₂ illustrates the light travelling direction of the sub-light beams toward the grating couplers 140. The number of the grating couplers 140 corresponds to the number of the sub-light beams. The grating couplers 140 adjust the light travelling directions into the arrow Lₐ₃ to direct the sub-light beams to the photodiodes 150. In this case, the grating coupler 140 may be called as the output grating coupler.

In some embodiments, the waveguide 125 and the waveguides 135 may be made of the same material as the grating coupler 120, the demultiplexer 130, and the grating coupler 140, so that the light beams can be effectively directed in the biosensor 100. For example, the waveguide 125 and the waveguides 135 may be made of Ta₂O₅ with a thickness in a range of 100 nm to 400 nm, SiN with a thickness in a range of 100 nm to 1000 nm, or the like.

Each of the sub-light beams from the light beam Lₐ is then irradiated onto each of the photodiodes 150, respectively. The number of the photodiodes 150 corresponds to the number of the grating couplers 140. In other words, the number of the photodiodes 150 corresponds to the number of the channels in the demultiplexer 130. In the embodiments which the light beam Lₐ is the absorption signal of glucose with longer wavelength, the photodiodes 150 may be quantum dot organic photodiodes (QD-OPD) or Ge photodiodes (Ge PD).

FIG. 1C is an exemplary schematic view of the light paths in the biosensor 100 to illustrate the relationship between the optical elements and the wavelengths of the lights. The incident light IL may be a mixed light of a group of waves 1102 to 1108 in a first wavelength range 1100 and another group of waves 1202 to 1208 in a second wavelength range 1200, where the first wavelength range 1100 is non-overlapped with the second wavelength range 1200. Each of the waves 1102 to 1108 has a peak wavelength, where each of the peak wavelengths of the waves 1102 to 1108 is different from any of the other peak wavelengths. Similarly, each of the waves 1202 to 1208 has a peak wavelength, where each of the peak wavelengths of the waves 1202 to 1208 is different from any of the other peak wavelengths. The meta-lens 110 refracts the incident light IL into a light beam Lₐ within the first wavelength range 1100 and a light beam L_{b} within the second wavelength range 1200. In other words, the light beam Lₐ includes the waves 1102 to 1108 while the light beam L_{b} includes the waves 1202 to 1208. The light beam Lₐ is directed to the demultiplexer 130 and demultiplexed into a plurality of sub-light beams by the demultiplexer 130, where each of the sub-light beams is composed of a corresponding one of the waves 1102 to 1108. When these sub-light beams are irradiated onto the photodiodes 150a to 150d, each of the waves 1102 to 1108 is corresponding to each of the photodiodes 150a to 150d, respectively.

After the sub-light beams from the light beam Lₐ are irradiated onto the photodiodes 150, the photodiodes 150 convert the intensity of sub-light beams into electrical signals. The traces 160 connected to the photodiodes 150 may transmit the electrical signals to an analyzer to measure the electrical signals of different photodiodes 150 and define the glucose concentration of the sample. The electrical signals of photodiodes 150 may also be measured by the analyzer in real-time to dynamically analyze the changes in glucose spectrum. Since the meta-lens 110 in the biosensor 100 acts as an optical filter for the light beam Lₐ, the meta-lens 110 may improve the accuracy of the analyzer monitoring the absorption signal of glucose. In some embodiments, a lock-in amplifier may be connected between the photodiodes 150 and the analyzer to amplify the electrical signals from the photodiodes 150.

The elements of the biosensor 100 are separated into multiple layers, thereby reducing the number of elements in each layer and simplifying the manufacturing process of the biosensor 100. For example, the biosensor 100 may include a first layer 170 and a second layer 175 below the first layer 170. In the first layer 170, the grating coupler 120, the waveguide 125, the demultiplexer 130, the waveguides 135, and the grating couplers 140 are disposed on the lower layer 172 and covered by the upper layer 174. The meta-lens 110 is disposed above the first layer 170. In the second layer 175, the photodiodes 150 and the traces 160 are disposed on the lower layer 176 and covered by the upper layer 178.

In some embodiments, the meta-lens 110 may be directly disposed on the top surface of the upper layer 174, as shown in FIG. 1B and FIG. 2A. In such embodiments, the upper layer 174 acts as a medium layer between the meta-lens 110 and the grating coupler 120, where a refractive index of the upper layer 174 is smaller than the refractive index of the substrate 112 of the meta-lens 110 to refract and split the light beam Lₐ and the light beam L_{b}. For example, the upper layer 174 may be made of air, glass, or other material with a refractive index about 1.0, while the refractive index of the substrate 112 is about 1.5. The lower layer 172 and the upper layer 178 may be a glass layer, and the lower layer 176 may be a silicon substrate or a glass substrate. Although the upper layer 178 is separated from the lower layer 172 in FIG. 1B, the lower layer 172 and the upper layer 178 may be a single layer with continuous material in some other embodiments.

In some embodiments, the biosensor 100 may include reflective patterns near the grating coupler 120 and the grating couplers 140 to reduce the light leakage, which improves the accuracy of the biosensor 100. For example, the biosensor 100 may include a reflective pattern 180 below the grating coupler 120 and a reflective pattern 182 above the grating couplers 140. The reflective pattern 180 may be disposed in the second layer 175 directly below the grating coupler 120, and the reflective pattern 182 may be disposed on the first layer 170 directly above the grating couplers 140. The reflective pattern 180 and the reflective pattern 182 may be distributed Bragg reflectors (DBR) or patterned layers made of Al₂O₃ or other reflective materials for the light beam Lₐ.

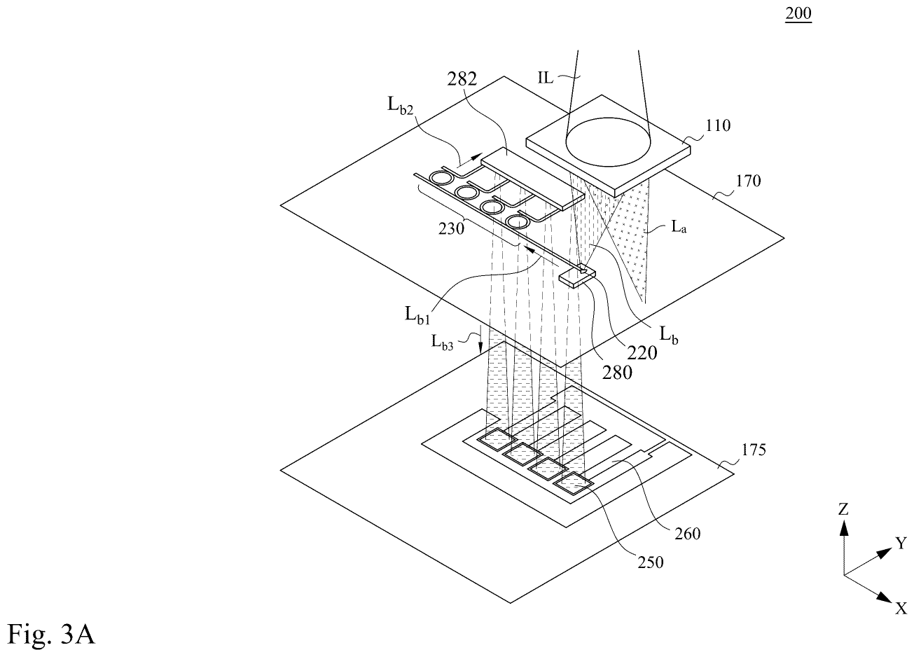

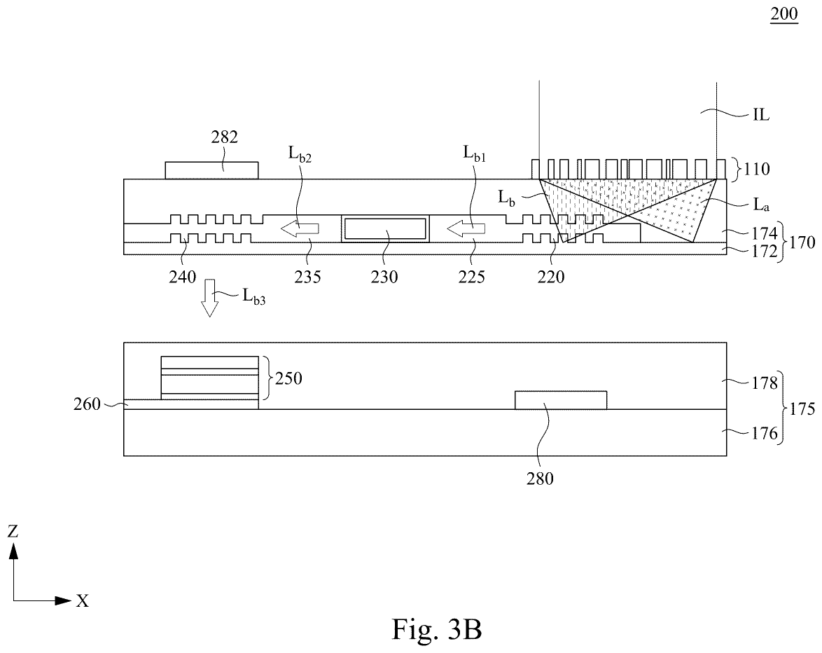

According to another embodiment of the present disclosure, FIG. 3A illustrates a three-dimensional schematic view of a biosensor 200 for glucose detection, and FIG. 3B illustrates a schematic cross-sectional view of the biosensor 200 in FIG. 3A. The biosensor 200 is similar to the biosensor 100 in FIG. 1A, but the biosensor 200 mainly detects the light beam L_{b} rather than the light beam Lₐ.

Specifically, the biosensor 200 includes a grating coupler 220 below the meta-lens 110, a demultiplexer 230 connected to the grating coupler 220 by a waveguide 225, a plurality of grating couplers 240 connected to the demultiplexer 230 by waveguides 235, and a plurality of photodiodes 250 below the demultiplexer 230 and the grating couplers 240. The light beam L_{b} from the meta-lens 110 is directed to the demultiplexer 230 along the arrow L_{b1} by the grating coupler 220 and the waveguide 225, and the light beam L_{b} is then demultiplexed into a plurality of sub-light beams having different peak wavelengths by the demultiplexer 230. The sub-light beams from the light beam L_{b} are then directed to the grating couplers 240 along the arrow L_{b2} by the waveguides 235 and redirected to the photodiodes 250 along the arrow L_{b3} by the grating couplers 240. The photodiodes 250 convert the intensity of sub-light beams into electrical signals, where the electrical signals are transmitted to an analyzer by the traces 260 connected to the photodiodes 250. The biosensor 200 may include a reflective pattern 280 below the grating coupler 220 and a reflective pattern 282 above the grating couplers 240. The elements of the biosensor 200 are separated into the first layer 170 and the second layer 175 below the first layer 170.

When the light beam L_{b} is the Raman signal of glucose, the demultiplexer 230 may be a micro ring resonator (MRR). The FSR of the micro ring resonator can be adjusted to about 10 nm or smaller than 10 nm, which is suitable to demultiplex the Raman signal having smaller wavelength range, such as 850 nm to 860 nm. After the light beam L_{b} being demultiplexed by the micro ring resonator mentioned-above, the FWHM of each sub-light beam can be tuned about 1 nm or smaller than 1 nm. In addition, the sub-light beams produced by the micro ring resonator may have high signal-noise ratio (SNR), which improves the sensitivity of the biosensor 200. In the embodiments which the light beam L_{b} is the Raman signal of glucose with shorter wavelength, the photodiodes 250 may be organic photodiodes (OPD) or inorganic photodiodes (PD). Since the meta-lens 110 in the biosensor 200 acts as an optical filter for the light beam L_{b}, the meta-lens 110 may improve the accuracy of the biosensor 200 detecting the Raman signal of glucose.

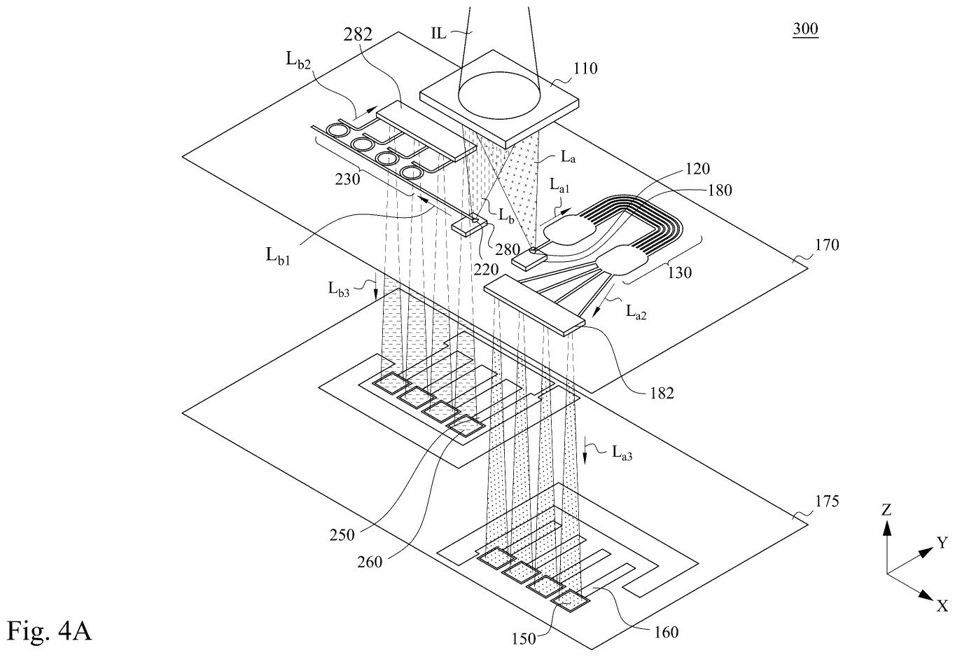

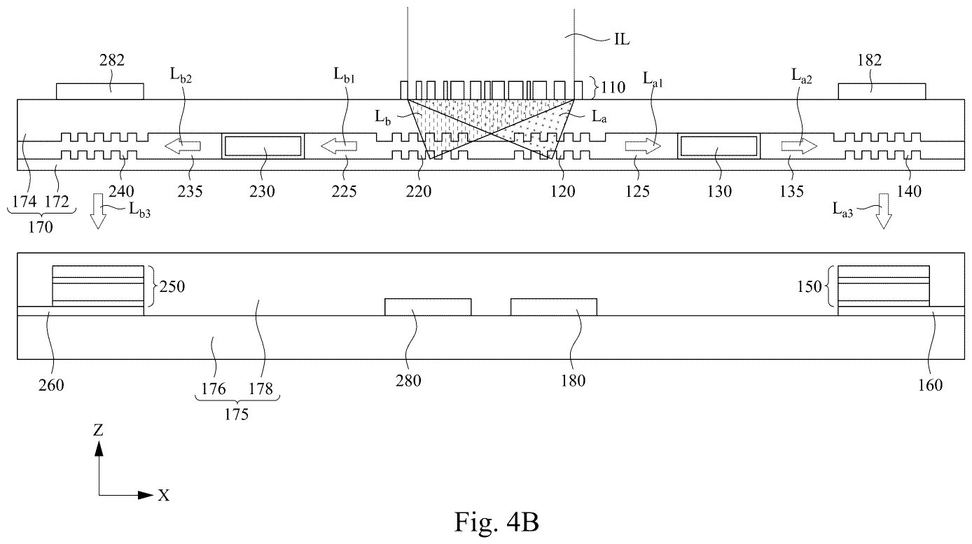

According to another embodiment of the present disclosure, FIG. 4A illustrates a three-dimensional schematic view of a biosensor 300, and FIG. 4B illustrates a schematic cross-sectional view of the biosensor 300 in FIG. 4A. The biosensor 300 combines the elements of the biosensor 100 in FIG. 1A and the elements of the biosensor 200 in FIG. 3A to detect both the light beam Lₐ and the light beam L_{b}. Specifically, the incident light IL is refracted into the light beam Lₐ and the light beam L_{b} by one meta-lens 110. The light beam Lₐ and the light beam L_{b} are directed to the demultiplexer 130 and the demultiplexer 230, respectively. In the embodiments which the wavelength range of the light beam Lₐ is larger than the wavelength range of the light beam L_{b}, the demultiplexer 130 with a larger FSR may be an array waveguide grating while the demultiplexer 230 with a smaller FSR may be a micro ring resonator. Since the FSR of the array waveguide grating is larger than the FSR of the micro ring resonator, the FWHM of each sub-light beam generated by the array waveguide grating may be correspondingly larger than the FWHM of each sub-light beam generated by the micro ring resonator. In other words, each of the sub-light beams generated by the demultiplexer 130 may have a bandwidth larger than a bandwidth of each of the sub-light beams generated by the demultiplexer 230. As a result, the photodiodes 150 and the photodiodes 250 detect the sub-light beams within different wavelength ranges and with different bandwidths.

The meta-lens 110 in the biosensor 300 acts as an optical splitter for the incident light IL, which makes it possible to detect both the absorption signal and the Raman signal of glucose with improved spectrum resolution. In some embodiments, the light beam Lₐ and the light beam L_{b} may be simultaneously irradiated onto the grating coupler 120 and the grating coupler 220, so that the photodiodes 150 and the photodiodes 250 simultaneously detect the absorption signal and the Raman signal to reduce the measurement error. In some other embodiments, the light beam Lₐ and the light beam L_{b} may be alternately irradiated onto the grating coupler 120 and the grating coupler 220. The photodiodes 150 and the photodiodes 250 alternately detect the sub-light beams based on the alternate frequency of the light beam Lₐ and the light beam L_{b} irradiated onto the grating coupler 120 and the grating coupler 220, which improves the signal-noise ratio of the biosensor 300.

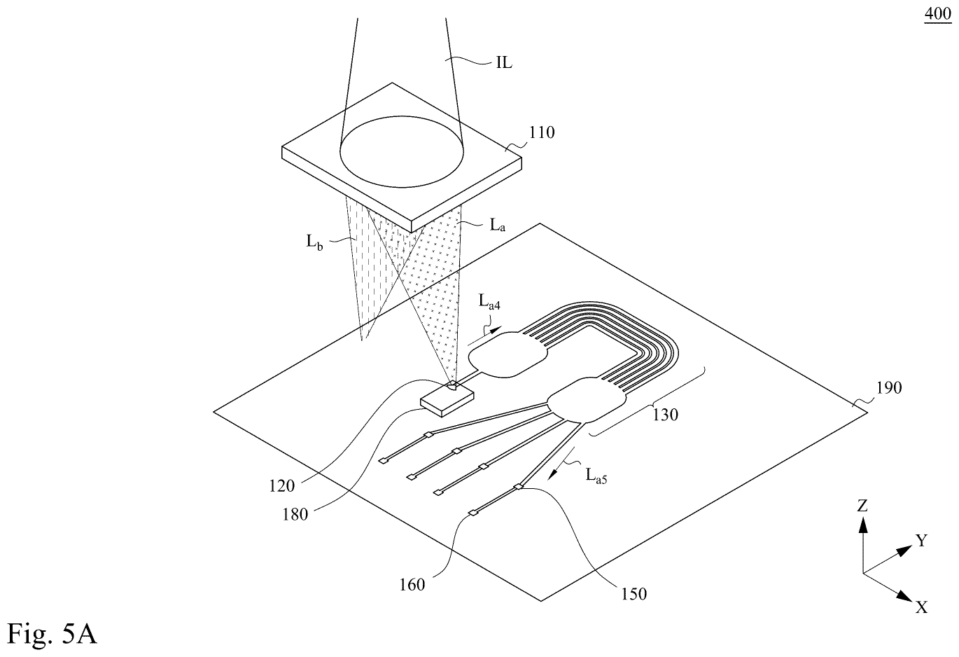

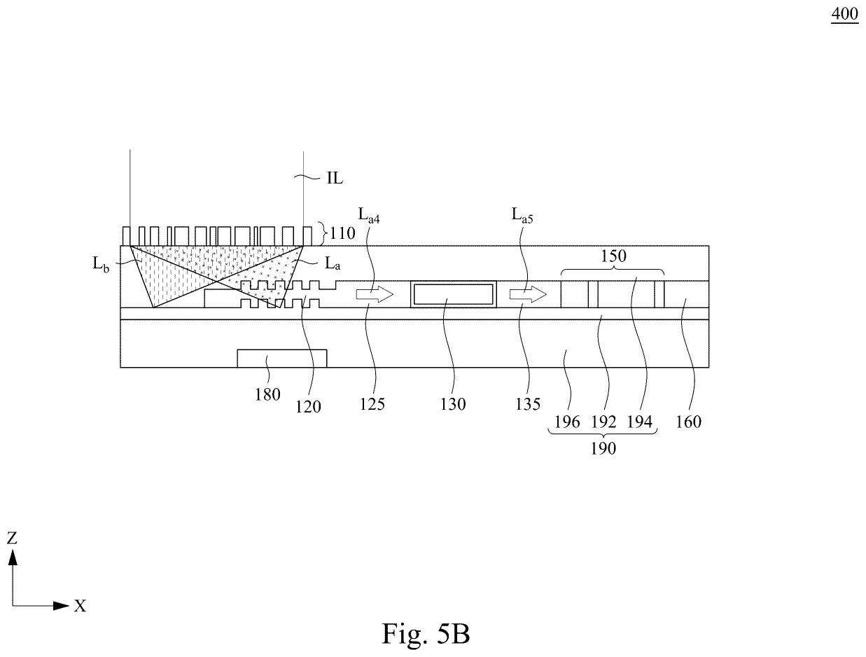

According to another embodiment of the present disclosure, FIG. 5A illustrates a three-dimensional schematic view of a biosensor 400, and FIG. 5B illustrates a schematic cross-sectional view of the biosensor 400 in FIG. 5A. The biosensor 400 is similar to the biosensor 100 in FIG. 1A, but the layers in the biosensor 400 are fewer than the layers in the biosensor 100.

Specifically, the biosensor 400 includes a grating coupler 120 below the meta-lens 110, a demultiplexer 130 connected to the grating coupler 120 by a waveguide 125, and a plurality of photodiodes 150 connected to the demultiplexer 130 by waveguides 135, where the photodiodes 150 are levelled with the grating coupler 120 and the demultiplexer 130 in one layer 190. The layer 190 includes a lower layer 192 and an upper layer 194 on a substrate 196, where the details of the lower layer 192, the upper layer 194, and the substrate 196 may refer to the lower layer 172, the upper layer 174, and the lower layer 176 of the biosensor 100 in FIG. 1A. The grating coupler 120, the waveguide 125, the demultiplexer 130, the waveguides 135, and the photodiodes 150 are disposed on the lower layer 192 and covered by the upper layer 194. The reflective pattern 180 may be disposed in the substrate 196 below the grating coupler 120.

The light beam Lₐ from the meta-lens 110 is directed to the demultiplexer 130 along the arrow Lₐ₄ by the grating coupler 120 and the waveguide 125, demultiplexed into a plurality of sub-light beams by the demultiplexer 130, and directed to the photodiodes 150 along the arrow Lₐ₅ by the waveguides 135. The light beams travelling in the levelled elements in the layer 190 may improve the transmission efficiency of the light beams and reduce the total thickness of the biosensor 400. In this case, the output grating couplers and their reflective pattern, such as the grating couplers 140 and the reflective pattern 182 in FIG. 1A, may be omitted in the biosensor 400.

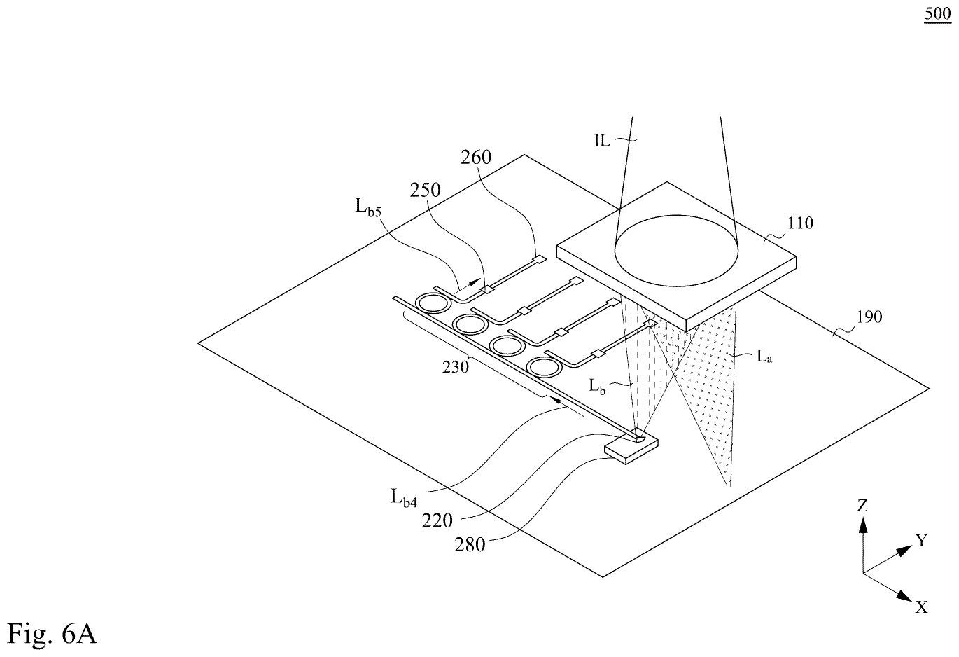

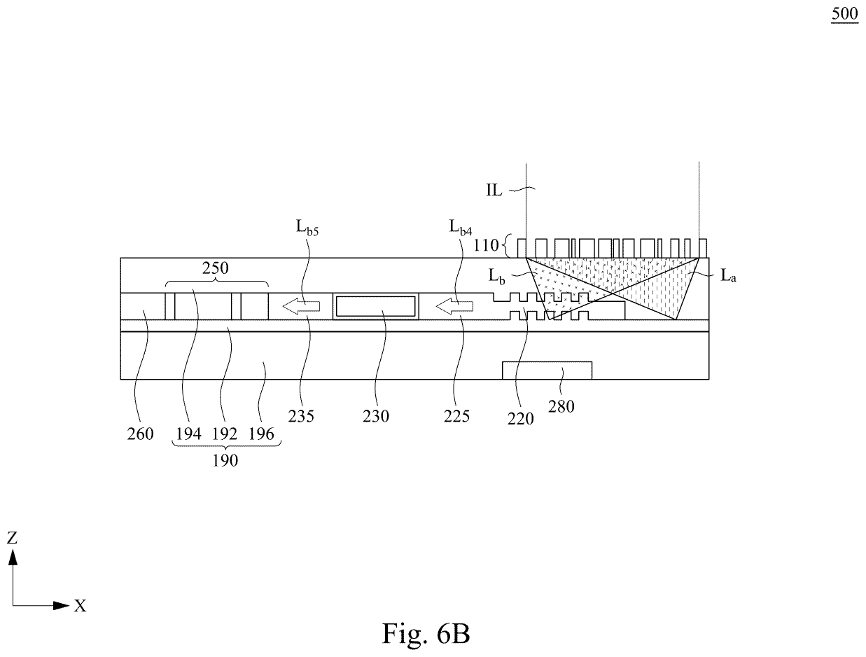

According to another embodiment of the present disclosure, FIG. 6A illustrates a three-dimensional schematic view of a biosensor 500, and FIG. 6B illustrates a schematic cross-sectional view of the biosensor 500 in FIG. 6A. The biosensor 500 is similar to the biosensor 400 in FIG. 5A, but the biosensor 500 mainly detects the light beam L_{b} rather than the light beam Lₐ. Specifically, the biosensor 500 includes most of the elements of the biosensor 200 in FIG. 3A, except for the grating couplers 240 and the reflective pattern 282. The grating coupler 220, the demultiplexer 230, and the photodiodes 250 are arranged in one layer 190, which is similar to the arrangement in the biosensor 400 in FIG. 5A. The light beam L_{b} from the meta-lens 110 is directed to the demultiplexer 230 along the arrow L_{b4} by the grating coupler 220 and the waveguide 225, demultiplexed into a plurality of sub-light beams by the demultiplexer 230, and directed to the photodiodes 250 along the arrow L_{b5} by the waveguides 235. The light beams travelling in the levelled elements in the layer 190 may improve the transmission efficiency of the light beams and reduce the total thickness of the biosensor 500.

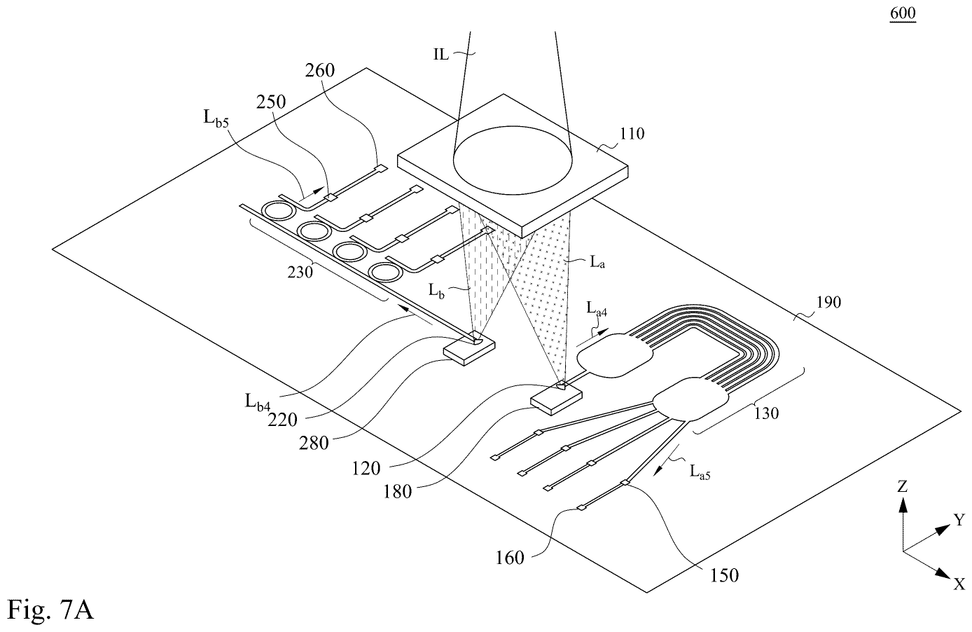

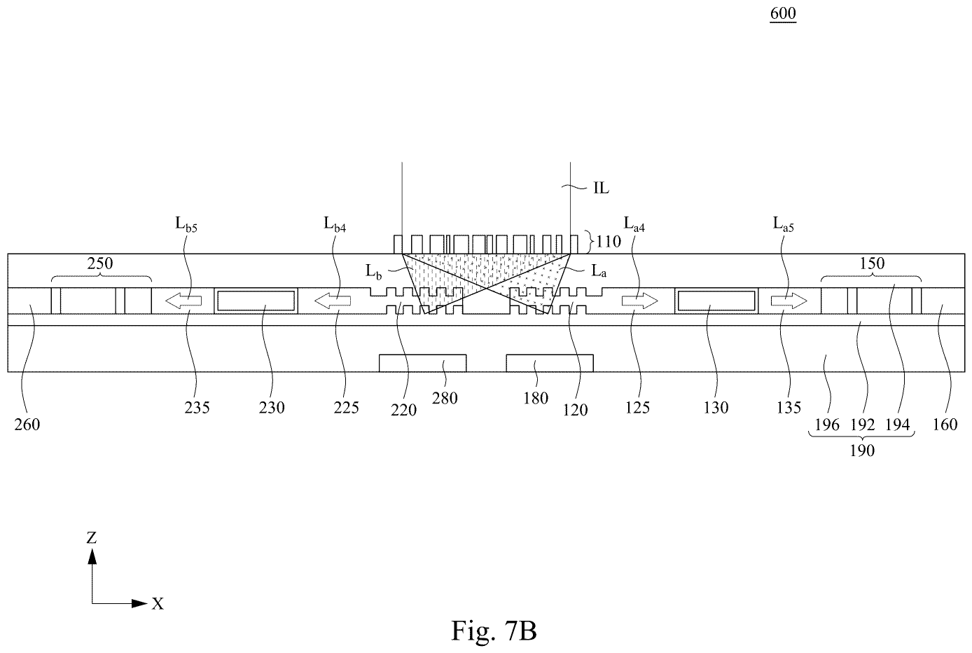

According to another embodiment of the present disclosure, FIG. 7A illustrates a three-dimensional schematic view of a biosensor 600, and FIG. 7B illustrates a schematic cross-sectional view of the biosensor 600 in FIG. 7A. The biosensor 600 combines the elements of the biosensor 400 in FIG. 5A and the elements of the biosensor 500 in FIG. 6A to analyze both the absorption signal and the Raman signal of glucose with improved spectrum resolution. The light beam Lₐ and the light beam L_{b} are spatially spaced apart by the meta-lens 110, and the two light beams are directed to the demultiplexer 130 and the demultiplexer 230 having different FSR, respectively. As a result, the photodiodes 150 and the photodiodes 250 detect the sub-light beams with different bandwidths and within the different wavelength range, so that the biosensor 600 may detect both the absorption signal and the Raman signal. The splitting of the light beam Lₐ and the light beam L_{b} by the meta-lens 110 may improve the accuracy and the signal-noise ratio of the biosensor 600.

According to the above-mentioned, the biosensor for glucose detection of the present disclosure includes the meta-lens, at least one demultiplexer, and the photodiodes. The light beams with different wavelength ranges are spatially spaced apart by the meta-lens, so the demultiplexer may demultiplex one of the light beams into the sub-light beams within the specific wavelength range and suitable bandwidth. As a result, a group of the photodiodes may detect the sub-light beams corresponding to one of the absorption signal or the Raman signal, which improves the accuracy and the signal-noise ratio of the biosensor. When the biosensor includes multiple demultiplexers, each of the demultiplexers may demultiplex one of the light beams from the meta-lens. Therefore, the biosensor may detect both the absorption signal and the Raman signal of glucose with improved spectrum resolution.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A biosensor for glucose detection, comprising:
a meta-lens, refracting an incident light into a first light beam and a second light beam spatially spaced apart from the first light beam, wherein a first wavelength range of the first light beam is non-overlapped with a second wavelength range of the second light beam;
a first grating coupler below the meta-lens, directing the first light beam;
a first demultiplexer, demultiplexing the first light beam into a plurality of first sub-light beams,
wherein each of the plurality of first sub-light beams has a peak wavelength, and each of the peak wavelengths is different from any of the other peak wavelengths; and
a plurality of first photodiodes below or levelled with the first demultiplexer, wherein each of the plurality of first sub-light beams is corresponding to each of the plurality of first photodiodes, respectively.

2. The biosensor for glucose detection of claim 1, wherein the meta-lens comprises a substrate and a plurality of nano-columns embedded in the substrate, and a refractive index of the plurality of the nano-columns is larger than a refractive index of the substrate.

3. The biosensor for glucose detection of claim 2, further comprising:
a medium layer between the meta-lens and the first grating coupler, wherein a refractive index of the medium layer is smaller than the refractive index of the substrate.

4. The biosensor for glucose detection of claim 1, wherein the meta-lens comprises a plurality of meta-lens units, each of the plurality of meta-lens units comprises:
a first nano-column having a first diameter;
a second nano-column having a second diameter larger than the first diameter;
a third nano-column having a third diameter smaller than the first diameter and the second diameter;
a fourth nano-column having a fourth diameter larger than the third diameter but smaller than the second diameter;
a fifth nano-column having a fifth diameter larger than the fourth diameter but smaller than the second diameter; and
a sixth nano-column having a sixth diameter larger than the fifth diameter but smaller than the second diameter,
wherein the first nano-column, the second nano-column, the third nano-column, the fourth nano-column, the fifth nano-column, and the sixth nano-column are sequentially arranged in a line.

5. The biosensor for glucose detection of claim 1, wherein the first light beam is focused on the first grating coupler by the meta-lens.

6. The biosensor for glucose detection of claim 1, wherein a minimum wavelength of the first wavelength range is larger than a maximum wavelength of the second wavelength range, and wherein a first angle of refraction of the first light beam through the meta-lens is larger than a second angle of refraction of the second light beam through the meta-lens.

7. The biosensor for glucose detection of claim 6, wherein a difference between the first angle of refraction and the second angle of refraction is equal to or larger than 15°.

8. The biosensor for glucose detection of claim 1, wherein the first wavelength range is larger than the second wavelength range, and the first demultiplexer is an array waveguide grating.

9. The biosensor for glucose detection of claim 8, wherein the plurality of the first photodiodes are quantum dot organic photodiodes or Ge photodiodes.

10. The biosensor for glucose detection of claim 1, wherein the first wavelength range is smaller than the second wavelength range, and the first demultiplexer is a micro ring resonator.

11. The biosensor for glucose detection of claim 10, wherein the plurality of the first photodiodes are organic photodiodes or inorganic photodiodes.

12. The biosensor for glucose detection of claim 1, further comprising:
a second grating coupler below the meta-lens, directing the second light beam;
a second demultiplexer, demultiplexing the second light beam into a plurality of second sub-light beams,
wherein each of the plurality of second sub-light beams has a peak wavelength, and each of the peak wavelengths of the second sub-light beams is different from any of the other peak wavelengths; and
a plurality of second photodiodes below or levelled with the second demultiplexer, wherein each of the plurality of second sub-light beams is corresponding to each of the plurality of second photodiodes, respectively.

13. The biosensor for glucose detection of claim 12, wherein the first demultiplexer is an array waveguide grating, the second demultiplexer is a micro ring resonator, and each of the plurality of first sub-light beams has a wavelength range larger than a wavelength range of each of the plurality of second sub-light beams.

14. The biosensor for glucose detection of claim 12, wherein the second light beam reaching a top surface of the second grating coupler is spatially spaced apart from the first light beam reaching a top surface of the first grating coupler by a first distance D1, the first grating coupler and the second grating coupler are separated from the meta-lens by a second distance D2, the first light beam through the meta-lens has a first angle of refraction θ1, and the second light beam through the meta-lens has a second angle of refraction θ2,
and wherein a relationship between the first distance D1, the second distance D2, the first angle of refraction θ1, and the second angle of refraction θ2 meets: D1=(tan θ1−tan θ2)×D2.

15. The biosensor for glucose detection of claim 12, wherein the first light beam and the second light beam are alternately irradiated onto the first grating coupler and the second grating coupler.

16. The biosensor for glucose detection of claim 1, wherein the first grating coupler, the first demultiplexer, and the plurality of the first photodiodes are connected by waveguides when the plurality of the first photodiodes are levelled with the first demultiplexer.

17. The biosensor for glucose detection of claim 1, further comprising a plurality of second grating couplers when the plurality of the first photodiodes are below the first demultiplexer, wherein the plurality of the second grating couplers directs the plurality of the first sub-light beams from the first demultiplexer to the plurality of the first photodiodes.

18. The biosensor for glucose detection of claim 17, wherein the first grating coupler, the first demultiplexer, and the plurality of the second grating couplers are connected by waveguides.

19. The biosensor for glucose detection of claim 17, further comprising a reflective pattern above the plurality of the second grating couplers.

20. The biosensor for glucose detection of claim 1, further comprising a reflective pattern below the first grating coupler.
